(19) United States
(12) Patent Application Publication
(10) Pub. No.: US 2015/0035886 A1
(43) Pub. Date: Feb. 5, 2015

(54) FORMATION OF DETECTION REGIONS BY DETECTOR MODULES COUPLED TO A MOVABLE CARRIAGE

(71) Applicant: Hewlett-Packard Development Company, L.P., Houston, TX (US)

(72) Inventors: Andrew Maxwell Frost, Sant Cugat del Valles (ES); Xavier Gasso Puchal, Barcelona (ES); Emilio Jose Gongora Canada, Sant Cugat del Valles (ES); Lluis Pous, Sant Cugat del Valles (ES); Xavier Soler Pedemonte, Barcelona (ES)

(73) Assignee: Hewlett-Packard Development Company, L.P., Houston, TX (US)

(21) Appl. No.: 13/955,232

(22) Filed: Jul. 31, 2013

(51) Int. Cl. B41J 29/387

(52) U.S. Cl. CPC B41J 29/387
USPC 347/14

(57) ABSTRACT

A printing apparatus includes a carriage, a first detector module, and a second detector module. The carriage may selectively move a fluid applicator along a scanning path in a first scanning direction and a second scanning direction across a print zone to print on a media therein. The first detector module and second detector module may be coupled to the carriage. Further, the first detector module may include a first receiver and a first source to form a first detection region there between downstream of the carriage in the first scanning direction to detect an object therein. The second detector module may include a second receiver and a second source to form a second detection region there between downstream of the carriage in the second scanning direction to detect an object therein.

### BACKGROUND

Printers may include movable carriages to move in a bi-directional manner across media. The respective carriage may hold a removable printhead or set of removable printheads to selectively print on the media as it is transported across the media. Periodically, the media may deform resulting in media bulges and/or media wrinkles that may extend into a scanning path of the carriage causing unintended contact with the carriage.

### BRIEF DESCRIPTION OF THE DRAWINGS

Non-limiting examples are described in the following description, read with reference to the figures attached hereto and do not limit the scope of the claims. Dimensions of components and features illustrated in the figures are chosen primarily for convenience and clarity of presentation and are not necessarily to scale. Referring to the attached figures:

FIG. 1 is a block diagram illustrating a printing apparatus according to an example.

FIG. 2 is a schematic view illustrating a printing apparatus according to an example.

FIG. 3A is a top view illustrating the printing apparatus of FIG. 2 according to an example.

FIG. 3B is a front view illustrating the printing apparatus of FIG. 2 according to an example.

FIG. 3C is a side view illustrating the printing apparatus of FIG. 2 according to an example.

FIG. 4 is a block diagram illustrating a printing system according to an example.

FIG. 5A is a schematic view illustrating the printing system of FIG. 4 according to an example.

FIG. 5B is a front view illustrating the printing system of FIG. 5A according to an example.

FIG. 5C is a top view illustrating the printing system of FIG. 5A according to an example.

FIG. 6 is a flowchart illustrating a detection method of a printing system according to an example.

### DETAILED DESCRIPTION

A printing apparatus such as an industrial inkjet printer, a desktop printer, and the like, may include a movable carriage to move a removable printhead along a scanning path in a bi-directional manner across a media. The media may advance each time a scanning movement of the carriage has been completed. The printhead may print on the media in a print zone as the carriage moves along the scanning path. Additionally, a small gap may exist in the print zone between the carriage and/or printhead installed therein, and the media to be printed on. At times, however, the media may deform resulting in media bulges and/or media wrinkles (e.g., media deformations) due to mechanical constrains and/or thermal constrains. Such media deformations may extend into the scanning path of the carriage resulting in it contacting the carriage and/or printhead installed therein once the carriage scans into the respective area. Consequently, image degradation and/or component damage of the printing apparatus may occur.

In examples, a printing apparatus includes a carriage, a first detector module, and a second detector module. The carriage may selectively move a fluid applicator along a scanning path in a first scanning direction and a second scanning direction across a print zone to print on a media therein. The first detector module and second detector module may be coupled to the carriage. Further, the first detector module may form a first detection region downstream of the carriage in the first scanning direction to detect an object such as media deformations therein. The second detector module may form a second detection region downstream of the carriage in the second scanning direction to detect an object therein. Accordingly, the carriage may be stopped or any other control action to protect the printing apparatus and/or components therein prior to it contacting the object in response to a detection of the respective object in the scanning path of the carriage. Consequently, image degradation and/or component damage of the printing apparatus may be reduced.

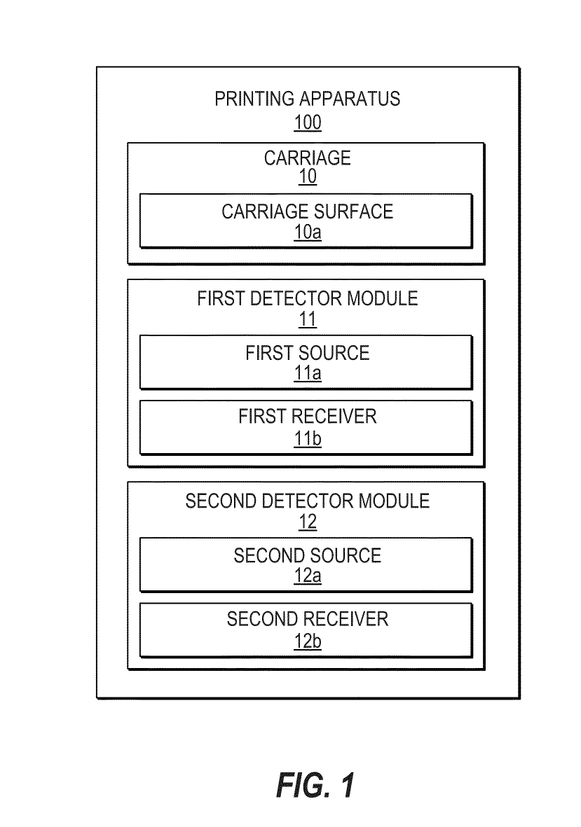

FIG. 1 is a block diagram illustrating a printing apparatus according to an example. Referring to FIG. 1, in some examples, a printing apparatus 100 includes a carriage 10, a first detector module 11, and a second detector module 12. The carriage 10 may receive a fluid applicator. In some examples, the carriage 10 may receive a plurality of fluid applicators. For example, the fluid applicator may include a printhead such as a replaceable inkjet printhead to eject printing fluid therefrom, and the like. In some examples, the printing fluid may be latex ink, ultraviolet curing ink, and the like. The carriage 10 may selectively move the fluid applicator along a scanning path in a first scanning direction and a second scanning direction across a print zone to print on a media therein. The carriage 10 may include a carriage surface 10a disposed to face the print zone. In some examples, the carriage surface 10a may include a surface of the fluid applicator such as a nozzle plate.

Referring to FIG. 1, in some examples, the first detector module 11 and the second detector module 12 may be coupled to the carriage 10. The first detector module 11 may include a first receiver 11b and a first source 11a to form a first detection region there between downstream of the carriage 10 in the first scanning direction to detect an object therein. For example, the first source 11a may provide a first signal to the first receiver 11b to form the first detection region there between. The second detector module 12 may include a second receiver 12b and a second source 12a to form a second detection region there between downstream of the carriage 10 in the second scanning direction to detect an object therein. For example, the second source 12a may provide a second signal to the second receiver 12b to form the second detection region there between. In some examples, the first source 11a, the second source 12a, the first receiver 11b, and the second receiver 12b are disposed outside of the print zone. For example, the print zone may be in an area adjacent to and between the surface of the fluid applicator installed in the carriage 10 and the media.

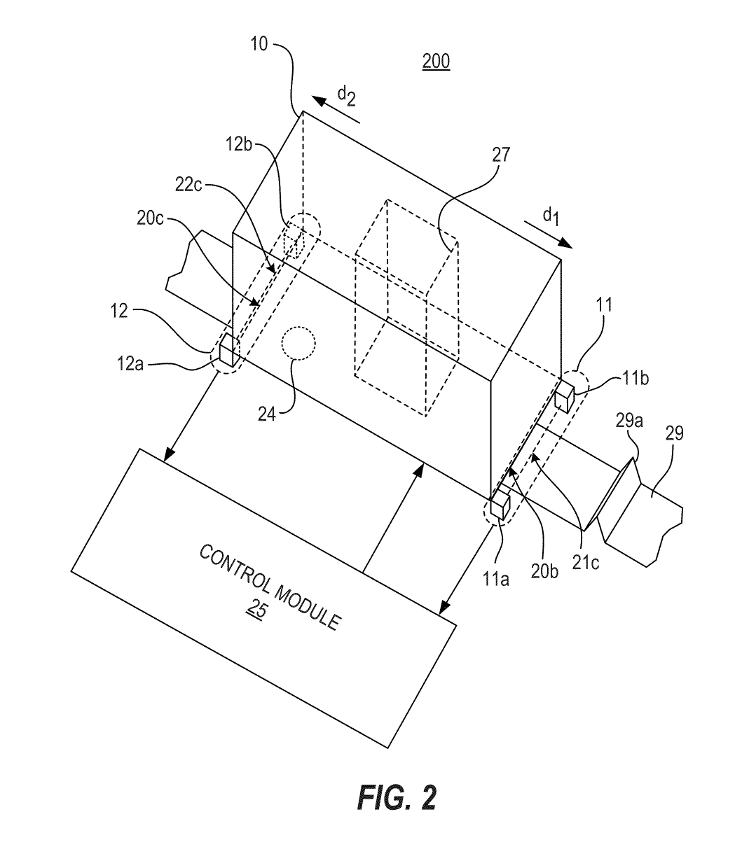

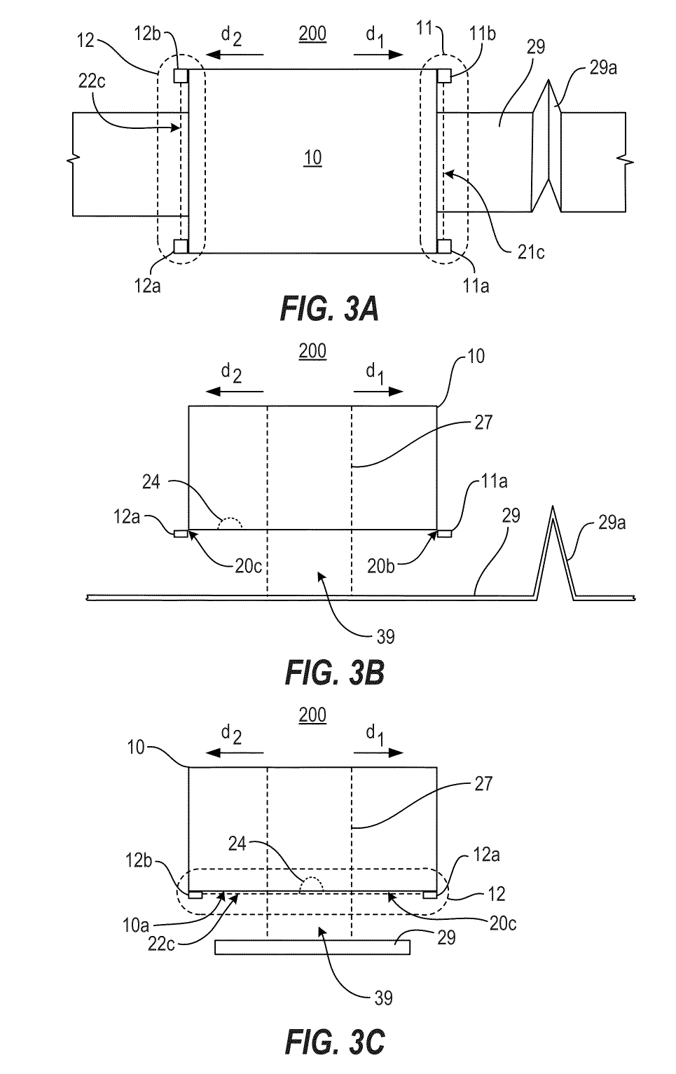

FIG. 2 is a schematic view illustrating a printing apparatus according to an example. FIG. 3A is a top view illustrating the printing apparatus of FIG. 2 according to an example. FIG. 3B is a front view illustrating the printing apparatus of FIG. 2 according to an example. FIG. 3C is a side view illustrating the printing apparatus of FIG. 2 according to an example. Referring to FIGS. 2-3C, in some examples, a printing apparatus 200 may include the carriage 10 including the carriage surface 10a, the first detector module 11, and the second detector module 12 as previously discussed with respect to the printing apparatus 100 of FIG. 1. In some examples, the printing apparatus 200 may also include a heater 24 and a control module 25.

Referring to FIGS. 2-3C, in some examples, the heater 24 may be coupled to the carriage 10. The heater 24 may selectively apply heat to the media 29 in the print zone 39, for example, to dry the media 29 and/or printing fluid placed thereon by the fluid applicator 27. The printing fluid may be latex ink, ultraviolet curing ink, and the like. In some examples, the printing apparatus 200 may include a plurality of heaters 24 coupled to the carriage 10. For example, the heaters 24 may be infrared heating lamps.

Referring to FIGS. 2-3C, in some examples, the control module 25 may communicate with the first detector module 11 and the second detector module 12. In some examples, the control module 25 may deactivate the heater 24 in response to a detection of the object 29a such as media deformations in at least one of the first detection region 21c and the second detection region 22c. Alternatively, or in addition, the control module 25 may stop movement of the carriage 10 in response to a detection of the object 29a in at least one of the first detection region 21c and the second detection region 22c.

In some examples, the control module 25 may be implemented in hardware, software including firmware, or combinations thereof. The firmware, for example, may be stored in memory and executed by a suitable, instruction-execution system. If implemented in hardware, as in an alternative example, the control module 25 may be implemented with any or a combination of technologies which are well known in the art (for example, discrete-logic circuits, application-specific integrated circuits (ASICs), programmable-gate arrays (PGAs), field-programmable gate arrays (FPGAs)), and/or other later developed technologies. In other examples, the control module 25 may be implemented in a combination of software and data executed and stored under the control of a computing device.

Referring to FIGS. 2-3C, in some examples, the first detector module 11 and a second detector module 12 may be coupled to the carriage 10. In some examples, each one of the first detector module 11 and the second detector module 12 may include a fiber optics through-beam detector. For example, the two fiber optics through-beam detectors may function as detection detectors in which each one emits a respective light beam proximate to a respective side 20b and 20c of the carriage 10. The respective detector module 11 and 12 may be activated once the input signal is under a predetermined threshold by the respective object 29a totally or partially obstructing the respective light beam. That is, the respective detector module 11 and 12 may identify when an object 29a is in the scanning path of the carriage 10, for example, to prevent the carriage 10 from contacting the object 29a. In some examples, the first detection region 21c and the second detection region 22c are proximate to and substantially parallel with corresponding edges 20b and 20c of the carriage surface 10a.

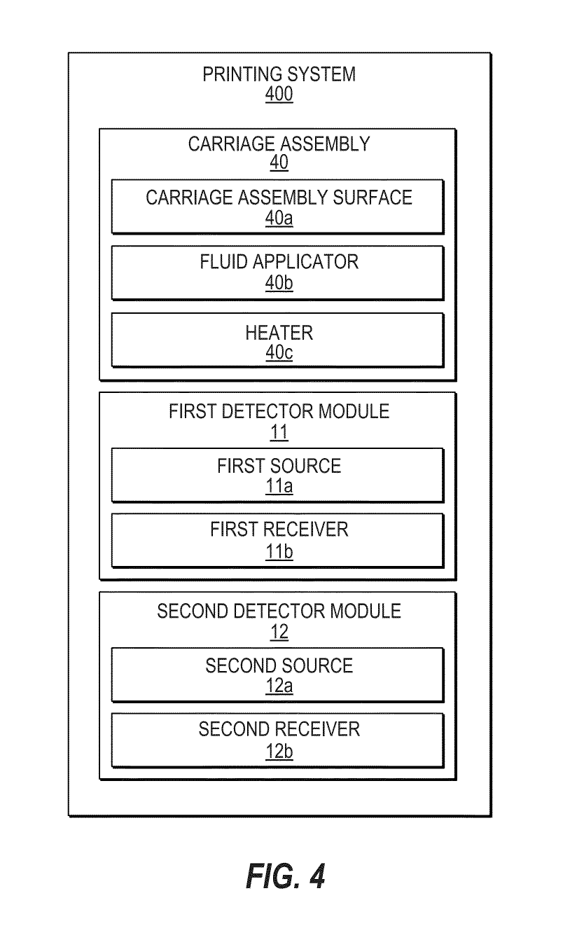

FIG. 4 is a block diagram illustrating a printing system according to an example. Referring to FIG. 4, in some examples, a printing system 400 may include a first detector module 11 and a second detector module 12 as previously discussed with respect to the printing apparatuses 100 and 200 of FIGS. 1 and 2. Referring to FIG. 4, in some examples, the printing system 400 may also include a carriage assembly 40. The carriage assembly 40 may include a carriage assembly surface 40a, a fluid applicator 40b, and a heater 40c. In some examples, the print zone may be in an area adjacent to and between the carriage assembly surface 40a and a media. For example, the print zone may be in the area adjacent to and between a surface of the fluid applicator of the carriage assembly 40b and the media.

Referring to FIG. 4, in some examples, the carriage assembly 40 may include a plurality of fluid applicators 40b and a plurality of heaters 40c. The carriage assembly 40 may move along a scanning path in a first scanning direction and a second scanning direction across the print zone to print on and heat the media therein. For example, the carriage assembly 40 may perform bi-directional printing in which printing may be performed while the carriage assembly 40 moves in the first scanning direction and the second scanning direction which may be opposite to the first scanning direction. The carriage assembly surface 40a may be disposed to face the print zone.

Referring to FIG. 4, in some examples, the first detector module 11 and the second detector module 12 may be coupled to the carriage assembly 40. The first detector module 11 may include a first receiver 11b and a first source 11a to form a first detection region there between downstream of the carriage assembly 40 in the first scanning direction to detect an object such as a media wrinkle and/or media bulge therein. For example, the first source 11a may provide a first signal to the first receiver 11b to form the first detection region there between.

Referring to FIG. 4, in some examples, the second detector module 12 may include a second receiver 12b and a second source 12a to form a second detection region there between downstream of the carriage assembly 40 in the second scanning direction to detect an object therein. For example, the second source 12a may provide a second signal to the second receiver 12b to form the second detection region there between. The first detection region and the second detection region may be proximate to and substantially parallel with corresponding edges of the carriage assembly surface 40a. In some examples, the first source 11a, the second source 12a, the first receiver 11b, and the second receiver 12b may be disposed outside of the print zone.

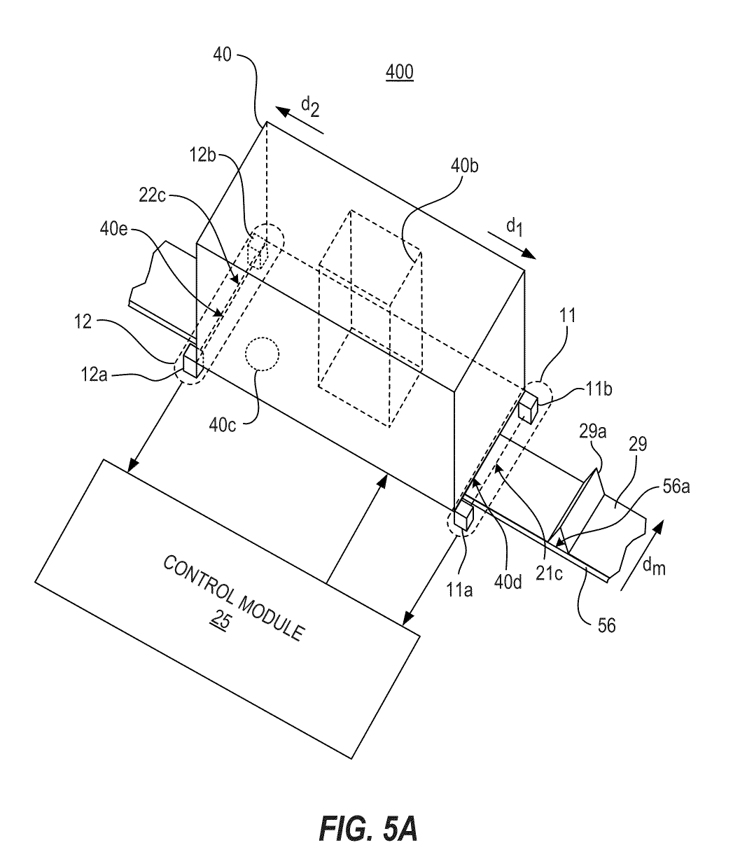

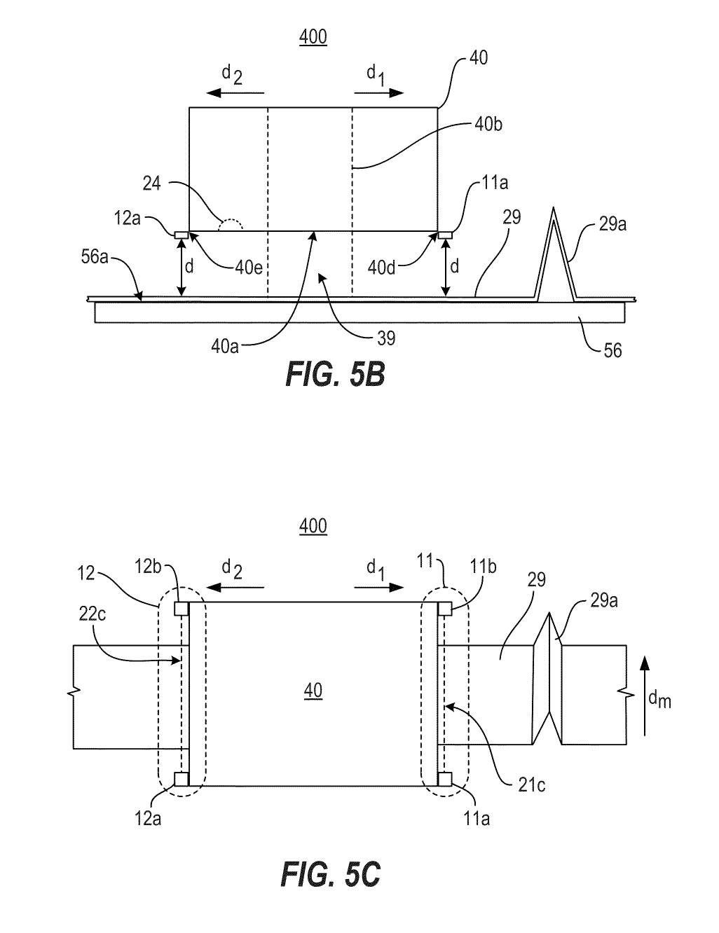

FIG. 5A is a schematic view illustrating the printing system of FIG. 4 according to an example. FIG. 5B is a front view illustrating the printing system of FIG. 5A according to an example. FIG. 5C is a top view illustrating the printing system of FIG. 5A according to an example. Referring to FIGS. 4-5C, in some examples, the printing system 400 may include the carriage assembly 40, the first detector module 11, and the second detector module 12 as previously discussed with respect to FIG. 4. Additionally, the carriage assembly 40a may include the carriage assembly surface 40a and the heater 40c as previously discussed with respect to FIG. 4. The carriage assembly 40 may also include a fluid applicator 40b. In some examples, the printing system 400 may also include a media transport assembly 56 and a control module 25.

Referring to FIGS. 4-50, in some examples, the media transport assembly 56 may include a media support surface 56a to support the media 29. In some examples, the media support surface 56a may be stationary. Alternatively, the media support surface 56a may be movable. The media transport assembly 56 may move the media 29 into and out of the print zone 39. In some examples, the media transport assembly 56 may selectively move the media 29 in a media advancement direction dₘ traverse to the first scanning direction d₁ and the second scanning direction d₂, for example, after completion of each carriage assembly movement in the first scanning direction d₁ and the second scanning direction d₂.

Referring to FIGS. 4-5C, in some examples, the carriage assembly surface 40a may include a surface of the fluid applicator 40b disposed to face the print zone 39. The carriage assembly surface 40a may include edges such as a first edge 40d and a second edge 40e. The first detection region 21c and the second detection region 22c may be proximate to and substantially parallel with corresponding edges 40d and 40e of the carriage assembly surface 40a. Additionally, the first detector module 11 may form a first detection region 21c there between downstream of the carriage assembly 40 in the first scanning direction d₁ to detect an object 29a therein. Also, the second detector module 12 may form a second detection region 22c there between downstream of the carriage assembly 40 in the second scanning direction d₂ to detect an object therein.

Referring to FIGS. 4-5C, in some examples, the control module 25 may communicate with the first detector module 11 and the second detector module 12. The first source 11a, the second source 12a, the first receiver 11b, and the second receiver 12b may be disposed outside of the print zone 39. The control module 25 may also stop movement of the carriage assembly 40 and/or deactivate the heater 40c in response to a detection of the respective object 29a such as media deformations of the media 29 in at least one of the first detection region 21c and the second detection region 22c. In some examples, the first detection region 21c, the second detection region 22c, and the carriage assembly surface 40a may be at a substantially same distance d from an imaginary plane extending through and parallel to the media support surface 56a.

Referring to FIGS. 4-5C, in some examples, the control module 25 may be implemented in hardware, software including firmware, or combinations thereof. The firmware, for example, may be stored in memory and executed by a suitable, instruction-execution system. If implemented in hardware, as in an alternative example, the control module 25 may be implemented with any or a combination of technologies which are well known in the art (for example, discrete-logic circuits, application-specific integrated circuits (ASICs), programmable-gate arrays (PGAs), field-programmable gate arrays (FPGAs)), and/or other later developed technologies. In other examples, the control module 25 may be implemented in a combination of software and data executed and stored under the control of a computing device.

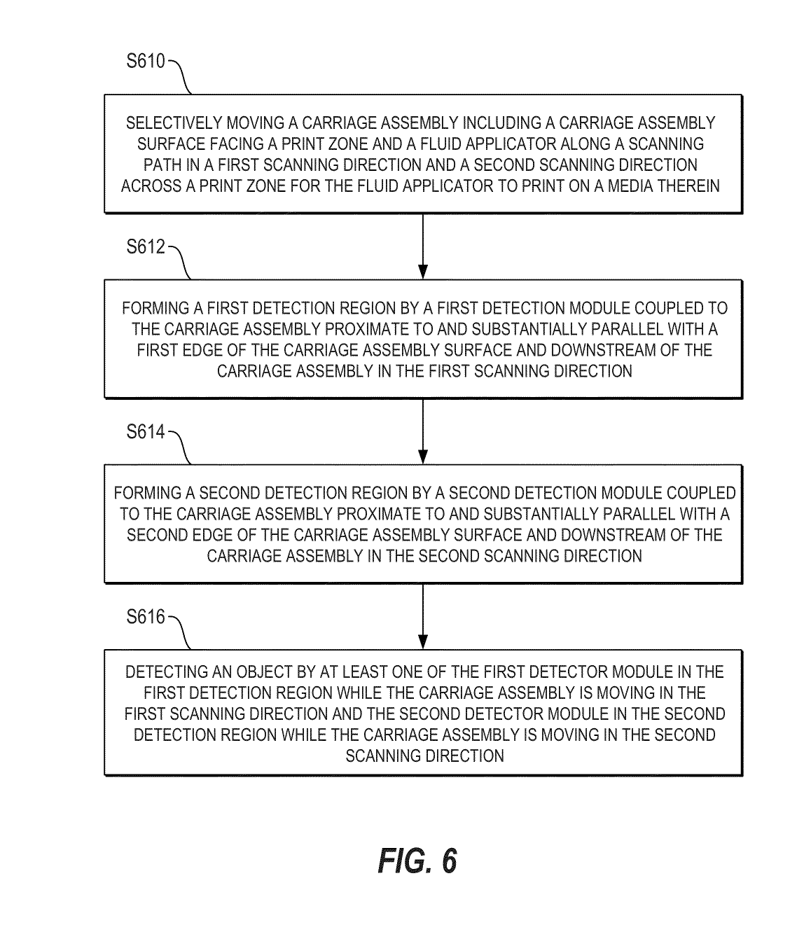

FIG. 6 is a flowchart illustrating a detection method of a printing system according to an example. In some examples, the modules, assemblies, and the like, previously discussed with respect to FIGS. 1-5C may be used to implement the detection method of FIG. 6. Referring to FIG. 6, in block S610, a carriage assembly including a fluid applicator and a carriage assembly surface facing a print zone is selectively moved along a scanning path in a first scanning direction and a second scanning direction across a print zone for the fluid applicator to print on a media therein. In block S612, a first detection region is formed by a first detection module coupled to the carriage assembly proximate to and substantially parallel with a first edge of the carriage assembly surface and downstream of the carriage assembly in the first scanning direction. For example, the first detection region may be formed between a first receiver disposed outside of the print zone and a first source disposed outside of the print zone.

In block S614, a second detection region is formed by a second detection module coupled to the carriage assembly proximate to and substantially parallel with a second edge of the carriage assembly surface and downstream of the carriage assembly in the second scanning direction. For example, the second detection region may be formed between a second receiver disposed outside of the print zone and a second source disposed outside of the print zone. In block S616, an object is detected by at least one of the first detector module in the first detection region while the carriage assembly is moving in the first scanning direction and the second detector module in the second detection region while the carriage assembly is moving in the second scanning direction. For example, the object may be media deformations that extend into a scanning path of the carriage assembly. In some examples, the first detector module and the second detector module may include a fiber optics through-beam detector.

The detecting method may also include communicating with the first detector module and the second detector module by a control module. Additionally, the method may also include stopping movement of the carriage assembly by the control module in response to detection of the object in at least one of the first detection region and the second detection region. The detection method may also include selectively applying heat to the media in the print zone by a heater coupled to the carriage assembly, and deactivating the heater by the control module in response to detection of the object in at least one of the first detection region and the second detection region. The detection method may also include transporting the media in a traverse direction to the first scanning direction and the second scanning direction after the carriage assembly is moved in one of the first scanning direction and the second scanning direction and before the carriage assembly moves in another of the first scanning direction and the second scanning direction.

It is to be understood that the flowchart of FIG. 6 illustrates architecture, functionality, and/or operation of examples of the present disclosure. If embodied in software, each block may represent a module, segment, or portion of code that includes one or more executable instructions to implement the specified logical function(s). If embodied in hardware, each block may represent a circuit or a number of interconnected circuits to implement the specified logical function(s). Although the flowchart of FIG. 6 illustrates a specific order of execution, the order of execution may differ from that which is depicted. For example, the order of execution of two or more blocks may be rearranged relative to the order illustrated. Also, two or more blocks illustrated in succession in FIG. 6 may be executed concurrently or with partial concurrence. All such variations are within the scope of the present disclosure.

The present disclosure has been described using non-limiting detailed descriptions of examples thereof that are not intended to limit the scope of the general inventive concept. It should be understood that features and/or operations described with respect to one example may be used with other examples and that not all examples have all of the features and/or operations illustrated in a particular figure or described with respect to one of the examples. Variations of examples described will occur to persons of the art. Furthermore, the terms “comprise,” “include,” “have” and their conjugates, shall mean, when used in the disclosure and/or claims, “including but not necessarily limited to.”

It is noted that some of the above described examples may include structure, acts or details of structures and acts that may not be essential to the general inventive concept and which are described for illustrative purposes. Structure and acts described herein are replaceable by equivalents, which perform the same function, even if the structure or acts are different, as known in the art. Therefore, the scope of the general inventive concept is limited only by the elements and limitations as used in the claims.

What is claimed is:

1. A printing apparatus, comprising:
a carriage to receive a fluid applicator and to selectively move the fluid applicator along a scanning path in a first scanning direction and a second scanning direction across a print zone to print on a media therein, the carriage having a carriage surface disposed to face the print zone;
a first detector module and a second detector module coupled to the carriage;
the first detector module including a first receiver and a first source to form a first detection region there between downstream of the carriage in the first scanning direction to detect an object therein; and
the second detector module including a second receiver and a second source to form a second detection region there between downstream of the carriage in the second scanning direction to detect an object therein; and
wherein the first source, the second source, the first receiver, and the second receiver are disposed outside of the print zone.

2. The printing apparatus of claim 1, wherein the first detection region and the second detection region are proximate to and substantially parallel with corresponding edges of the carriage assembly surface.

3. The printing apparatus of claim 1, wherein the carriage surface includes a surface of the fluid applicator disposed to face the print zone.

4. The printing apparatus of claim 1, further comprising:
a heater coupled to the carriage, the heater to selectively apply heat to the media in the print zone.

5. The printing apparatus of claim 4, further comprising:
a control module to communicate with the first detector module and the second detector module, the control module to at least one of stop movement of the carriage and deactivate the heater in response to a detection of the respective object in at least one of the first detection region and the second detection region.

6. The printing apparatus of claim 1, wherein each one of the first detector module and the second detector module include a fiber optics through-beam detector.

7. A printing system, comprising:
a carriage assembly including a fluid applicator, a heater, and a carriage assembly surface, the carriage assembly to move along a scanning path in a first scanning direction and a second scanning direction across a print zone to print on and heat the media therein such that the carriage assembly surface is disposed to face the print zone;
a first detector module and a second detector module coupled to the carriage assembly;
the first detector module including a first receiver and a first source to form a first detection region there between downstream of the carriage assembly in the first scanning direction, the first detection region is formed to detect an object therein; and
the second detector module including a second receiver and a second source to form a second detection region there between downstream of the carriage assembly in the second scanning direction, the second detection region is formed to detect an object therein; and
wherein the first detection region and the second detection region are proximate to and substantially parallel with corresponding edges of the carriage assembly surface.

8. The printing system of claim 7, wherein the first source, the second source, the first receiver, and the second receiver are disposed outside of the print zone.

9. The printing system of claim 7, further comprising:
a control module to communicate with the first detector module and the second detector module, the control module to at least one of stop movement of the carriage and deactivate the heater in response to a detection of the respective object in at least one of the first detection region and the second detection region.

10. The printing system of claim 7, further comprising:
a media transport assembly including a media support surface to support the media, the media transport assembly to transport the media in a traverse direction to the first scanning direction and the second scanning direction.

11. A detection method of a printing system the detection method comprising:
selectively moving a carriage assembly including a carriage assembly surface facing a print zone and a fluid applicator along a scanning path in a first scanning direction and a second scanning direction across a print zone for the fluid applicator to print on a media therein;
forming a first detection region by a first detection module coupled to the carriage assembly proximate to and substantially parallel with a first edge of the carriage assembly surface and downstream of the carriage assembly in the first scanning direction;
forming a second detection region by a second detection module coupled to the carriage assembly proximate to and substantially parallel with a second edge of the carriage assembly surface and downstream of the carriage assembly in the second scanning direction; and
detecting an object by at least one of the first detector module in the first detection region while the carriage assembly is moving in the first scanning direction and the second detector module in the second detection region while the carriage assembly is moving in the second scanning direction.

12. The detection method of claim 11, further comprising:
communicating with the first detector module and the second detector module by a control module; and
stopping movement of the carriage assembly by the control module in response to a detection of the object in at least one of the first detection region and the second detection region.

13. The detection method of claim 11, further comprising:
selectively applying heat to the media in the print zone by a heater coupled to the carriage assembly; and
deactivating the a heater by the control module in response to a detection of the object in at least one of the first detection region and the second detection region.

14. The detection method of claim 11, wherein the forming a first detection region by a first detection module coupled to the carriage assembly proximate to and substantially parallel with a first edge of the carriage assembly surface and downstream of the carriage assembly in the first scanning direction further comprises:
forming the first detection region between a first receiver disposed outside of the print zone and a first source disposed outside of the print zone.

15. The detection method of claim 11, wherein the forming a second detection region by a second detection module coupled to the carriage assembly proximate to and substantially parallel with a second edge of the carriage assembly surface and downstream of the carriage assembly in the second scanning direction further comprises:
forming the second detection region between a second receiver disposed outside of the print zone and a second source disposed outside of the print zone.
